(19) United States
(12) Patent Application Publication
(10) Pub. No.: US 2023/0126226 A1
(43) Pub. Date: Apr. 27, 2023

(54) Systems, Methods, and Media for Training a Model for Improved Out of Distribution Performance

(71) Applicant: Mayo Foundation for Medical Education and Research, Rochester, MN (US)

(72) Inventors: Iman J. Kalantari, Rochester, MN (US); Kia Khezeli, Rochester, MN (US)

(21) Appl. No.: 17/970,771

(22) Filed: Oct. 21, 2022

Related U.S. Application Data
(60) Provisional application No. 63/270,683, filed on Oct. 22, 2021.

(51) Int. Cl. G06V 10/774; G06V 10/776

(52) U.S. Cl. CPC G06V 10/774; G06V 10/776

(57) ABSTRACT

In accordance with some embodiments, systems, methods, and media for training a model for improved out of distribution performance are provided. In some embodiments, the method comprises: receiving a plurality of datasets, each associated with a different environment e; initializing data representation parameters associated with a model; providing the datasets as input to the model; receiving, from the model, an output associated with each input; determining an optimal classifier for the data representation parameters using an invariance penalty based on a square root of matrix [symbol] ₑ(φ):=E_{X}_{^{e}}[(φ(X^{e})φ(X^{e})^{T}] for e, where φ represents the data representation parameters, and φ(x^{e}) is the dataset associated with environment e modified based on the data representation parameters; calculating a loss value for the optimal classifier across the datasets; and modifying the data representation parameters based on the loss value.

### CROSS-REFERENCE TO RELATED APPLICATIONS

This application is based on, claims the benefit of, and claims priority to U.S. Provisional Application No. 63/270,683, filed Oct. 22, 2021, which is hereby incorporated herein by reference in its entirety for all purposes.

### STATEMENT REGARDING FEDERALLY SPONSORED RESEARCH

N/A

### BACKGROUND

Under the learning paradigm of Empirical Risk Minimization (ERM) data is assumed to include independent and identically distributed (iid) samples from an underlying generating distribution. As the data generating distribution is often unknown in practice, ERM attempts to identify predictors with minimal average training error (which can be referred to as empirical risk) over the training set. Despite becoming a ubiquitous paradigm in machine learning, a growing body of literature has revealed that ERM and the common practice of shuffling data often inadvertently results in capturing all correlations found in the training data, regardless of whether the correlations are spurious or causal. This often produces models that fail to generalize to test data. The potential variation of experimental conditions from training to the utilization in real-world applications manifests in discrepancy between training and testing distributions. Using such techniques can result in a machine learning model that fails to generalize out-of-distribution (OoD).

Accordingly, new systems, methods, and media for training a model for improved out of distribution performance are desirable.

### SUMMARY

In accordance with some embodiments of the disclosed subject matter, systems, methods, and media for training a model for improved out of distribution performance are provided.

In accordance with some embodiments of the disclosed subject matter, a method for training a model for improved out of distribution performance is provided, the method comprising: receiving a plurality of datasets, each dataset associated with a different environment e; initializing data representation parameters associated with a model; providing the plurality of datasets as input to the model; receiving, from the model, an output associated with each input; determining an optimal classifier for the data representation parameters using an invariance penalty based on a square root of matrix [symbol] ₑ(φ):=E_{X}_{^{e}}[φ(X^{e})φ(X^{e})^{T}] for each environment e, where φ represents the data representation parameters, and φ(X^{e}) is the dataset associated with environment e modified based on the data representation parameters; calculating a loss value for the optimal classifier across the plurality of datasets; and modifying the data representation parameters based on the loss value.

In some embodiments, the model comprises a convolutional neural network.

In some embodiments, the model comprises a regression model.

In some embodiments, determining the optimal classifier comprises determining w*(φ) using

$${w}^{★} ( φ ) := {arg min}_{w} {\sum }_{e ∈ {ε}_{t r}} {ℛ}_{e} ( {w}^{T} φ ) + {λρ}_{e}^{I R M v 2} ( φ , w ) , \\ where {ρ}_{e}^{I R M v 2} ( φ , w ) := {‖ {{𝒥}_{e} ( {φ}_{c} )}^{\frac{1}{2}} ( w - {w}_{e}^{★} ( φ ) ) ‖}^{2}$$

is an invariance penalty, where wₑ*(φ)= [symbol] ₑ(φ)⁻¹E_{X}_{^{e}}_{Y}_{^{e}}[φ(X^{e})Y^{e}].

In some embodiments, calculating the loss value for the optimal classifier across the plurality of datasets comprises calculating [symbol] ₜ(φ_{θ}_{ₜ}=Σ_{e∈ε}_{ₜᵣ} [symbol] ₑ(w*(φ_{θ}_{ₜ})^{T}φ_{θ}_{ₜ})+λ_{ρ}_{ₑ}^{IRMv2}(φ_{θ}_{ₜ},w*(φ_{θ}_{ₜ})), where θₜ comprises the data representation parameters at time t.

In some embodiments, modifying the data representation parameters based on the loss value comprises setting data representation parameters θₜ₊₁←θₜ−η∇_{θ} [symbol] ₜ(φ_{θ}_{ₜ}).

In some embodiments, a first environment of the plurality of environments corresponds to a first hospital and a second environment of the plurality of environments corresponds to a second hospital.

In accordance with some embodiments of the disclosed subject matter, a system for training a model for improved out of distribution performance is provided, the system comprising: at least one processor configured to: receive a plurality of datasets, each dataset associated with a different environment e; initialize data representation parameters associated with a model; provide the plurality of datasets as input to the model; receive, from the model, an output associated with each input; determine an optimal classifier for the data representation parameters using an invariance penalty based on a square root of matrix [symbol] ₑ(φ):=E_{X}_{^{e}}[(φ(X^{e})φ(X^{e})^{T}] for each environment e, where φ represents the data representation parameters, and φ(X^{e}) is the dataset associated with environment e modified based on the data representation parameters; calculate a loss value for the optimal classifier across the plurality of datasets; and modify the data representation parameters based on the loss value.

In accordance with some embodiments of the disclosed subject matter, a non-transitory computer readable medium containing computer executable instructions that, when executed by a processor, cause the processor to perform a method for training a model for improved out of distribution performance is provided, the method comprising: receiving a plurality of datasets, each dataset associated with a different environment e; initializing data representation parameters associated with a model; providing the plurality of datasets as input to the model; receiving, from the model, an output associated with each input; determining an optimal classifier for the data representation parameters using an invariance penalty based on a square root of matrix [symbol] ₑ(φ:=E_{X}_{^{e}}[(φ(X^{e})φ(X^{e})^{T}] for each environment e, where φ represents the data representation parameters, and φ(X^{e}) is the dataset associated with environment e modified based on the data representation parameters; calculating a loss value for the optimal classifier across the plurality of datasets; and modifying the data representation parameters based on the loss value.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for training a model for improved out of distribution performance in accordance with some embodiments of the disclosed subject matter.

FIG. 2 shows an example of hardware that can be used to implement a data source, a computing device, and a server, shown in FIG. 1 in accordance with some embodiments of the disclosed subject matter.

FIG. 3 shows an example of a flow for training a classification model using mechanisms for training a model for improved out of distribution performance in accordance with some embodiments of the disclosed subject matter.

FIG. 4 shows an example of various invariance penalties that can be used with invariance risk minimization techniques.

FIG. 5 shows an example of a process for training a model for improved out of distribution performance in accordance with some embodiments of the disclosed subject matter.

FIG. 6 shows an example of test errors observed for various classification models, including classification models trained in accordance with some embodiments of the disclosed subject matter.

FIG. 7 shows an example of test accuracy observed for various classification models, including classification models trained in accordance with some embodiments of the disclosed subject matter.

### DETAILED DESCRIPTION

In accordance with various embodiments, mechanisms (which can, for example, include systems, methods, and media) for training a model for improved out of distribution performance are provided.

In general, shuffling and treating data as iid risks possibly losing important information about the underlying conditions of the data generating process. In some embodiments, mechanisms described herein can partition training data into environments, which can be based on conditions under which the data was generated. Partitioning the training data can facilitate exploitation differences in environment to enhance generalization. A concept of Invariant Risk Minimization (IRM) can be used to attempt to utilize information provided by the different environments with the objective of finding a predictor that is invariant across all training environments (e.g., as described below in connection with EQ. (2)).

In some embodiments, mechanisms described herein can utilize an invariance penalty that can facilitate a practical implementation of IRM. For example, an invariance penalty can that is directly related to risk can be used. As described below, the risk in each environment under an arbitrary classifier can be shown to be equal to the risk under the invariant classifier for that environment and an invariance penalty between the arbitrary classifier and the optimal classifier. Additionally, the framework described below is shown to find an invariant predictor for the setting in which the data is generated according to a linear Structural Equation Model (SEM) when provided a sufficient number of training environments under a mild non-degeneracy condition.

Additionally, as described below, the eigenstructure of a Gram matrix of a data representation can also affect performance of a classifier trained using IRM techniques. For example, the Gram matrix is ill-conditioned in an example described in Rosenfeld et al., “The risks of invariant risk minimization,” in International Conference on Learning Representations (2021), in which an invariance penalty described in Arjovsky et al., “Invariant risk minimization,” arXiv:1907.02893 (2019) is made arbitrarily small. Differences between an invariance penalty described herein and an invariance penalty described in Arjovsky (2019) is also described below in terms of the eigenvalues of the Gram matrix of the data representation. This eigenstructure can plays a significant role in the failure of invariance penalties, including the penalty described in Arjovsky (2019).

In some embodiments, data (X^{e}, Y^{e}) can be collected from multiple training environments εₜᵣ where the distribution of (Xⁱ, Yⁱ) and (X^{j}, Y^{j}) may be different for i≠j, with i,j ∈εₜᵣ. For example, data can be collected at multiple healthcare institutions, and each institution can be considered as an environment e. In such an example, X^{e} can denote the input variables associated with environment e, and Y^{e} can denote the target variable associated with environment e. The risk m an environment e can be referred to as Rₑ. For a predictor f:X→ [symbol] , and a loss function [symbol] : [symbol] × [symbol] → [symbol] , the risk under environment e can be represented as

Rₑ(f)=E_{X}_{^{e}}_{,Y}_{^{e}}[ [symbol] (f(X^{e}),Y^{e})] (1)

The notion of invariant predictors under a multi-environment setting can be conceptualized using a data representation φ:X→ [symbol] which can elicit an invariant predictor w∘φ across environments ε if there exists a classifier w: [symbol] → [symbol] , which is optimal for all environments. The preceding can be expressed as

$$w ∈ {arg min}_{\tilde{w} : ℋ \to 𝓎} {R}_{e}$$

(\tilde{w}∘φ) for all e ∈ ε.

Invariant Risk Minimization (IRM) techniques can be used to attempt to find such invariant predictors. IRM can be represented as:

$${min}_{{φ : 𝒳 \to H}_{w ∈ {ℝ}^{{d}_{φ}}}} {\sum }_{e ∈ {ε}_{t r}} {R}_{e} ( w ∘ φ ) \qquad ( 2 )$$

$$subject to w ∈ {arg min}_{\tilde{w} : ℋ \to 𝓎} {R}_{e} ( {\tilde{w}}^{T} φ ) , ∀ e ∈ {ε}_{tr}$$

As this bi-leveled optimization problem is rather intractable, a more practical implementation of IRM can be implemented by relaxing the invariance constraint (which itself requires solving an optimization problem) to an invariance penalty.

For example, in order to provide an implementation of IRM, the classifier w can be restricted to linear functions as proposed by Arjovsky (2019), which can be used to

$${min}_{{φ : 𝒳 \to H}_{w ∈ {ℝ}^{{d}_{φ}}}} {\sum }_{e ∈ {ε}_{t r}} {R}_{e} ( {w}^{T} φ ) \qquad ( 3 )$$

$$subject to w ∈ {arg min}_{\tilde{w} : ℋ \to 𝓎} {R}_{e} ( {\tilde{w}}^{T} φ ) , ∀ e ∈ {ε}_{tr}$$

To motivate this proposed penalty, the squared loss (e.g., [symbol] (f(s), y)=∥f(x)−y∥² where ∥·∥ denotes the Euclidean norm). The matrix [symbol] ₑ(φ) can be expressed using:

[symbol]

ₑ(φ):=E_{X}_{^{e}}[φ(X^{e})φ(X^{e})^{T}]. (4)

where E represents the expected value with respect to X^{e}.

Assuming that [symbol] ₑ(φ) is full rank for a fixed φ, its respective optimal classifier w* can be unique, which can be represented using:

$${arg min}_{\tilde{w} : ℋ \to 𝓎} {R}_{e} ( {\tilde{w}}^{T} φ ) = {w}_{e}^{★} ( φ ) , \qquad ( 5 )$$

$${w}_{e}^{★} ( φ ) = {{𝒥}_{e} ( φ )}^{- 1} {E}_{{X}^{e} , {Y}^{e}} [ φ ( {X}^{e} ) {Y}^{e} ] . \qquad ( 6 )$$

In some embodiments, wₑ*(φ) can be a vector. For example, where target variable Y^{e} is a real number, wₑ*(φ) can be a vector. Alternatively, in some embodiments, wₑ*(φ) can be a matrix. For example, where target variable Y^{e} is a vector, wₑ*(φ) can be a matrix.

To relax the constraint w−wₑ*(φ)=0 to a penalty, one choice can be to use ∥w−wₑ*(φ)∥². However, Arjovsky (2019) noted that this penalty does not capture invariance by constructing an example for which ∥w−wₑ*(φ)∥² is not well-behaved. Using the insight from this example, an alternative penalty ∥ [symbol] ₑ(φ)(w−wₑ*(φ))∥² is proposed as an invariant penalty. For the squared loss, it can be shown that

∥ [symbol] ₑ(φ)(w−wₑ*(φ))∥²=(¼)∥∇_{w}Rₑ(w^{T}ϕ)∥². (7)

Accordingly, the alternative penalty can be represented as

ρₑ^{IRMv1}(φ,w):=∥∇_{w}Rₑ(w^{T}φ)∥² (8)

Using the penalty of EQ. (8), the relaxation of IRM can be represented as

$${min}_{φ , w} {\sum }_{e ∈ {ε}_{t r}} {R}_{e} ( {w}^{T} φ ) + {λφ}_{e}^{IRMv 1} ( φ , w ) , \qquad ( 9 )$$

where λ≥0 is a penalty coefficient. Note that for a given w and φ, predictor w ∘φ can be expressed using different classifiers and data representations (e.g., w ∘φ=\tilde{w}∘\tilde{φ}, where \tilde{w}=w ∘ψ⁻¹ and \tilde{φ}=ψ∘φ for some invertible mapping ψ: [symbol] → [symbol] . Accordingly, in principle, it is possible to fix w without loss of generality. Based on this observation, Arjovsky (2019) proposed fixing the classifier as a scalar w=1, and, thus, search for an invariant data representation of the form φ∈ [symbol] ^{1×d}^{ₓ}. Such a relaxation, which can be referred to as IRMv1, can be expressed as

$${min}_{φ} {\sum }_{e ∈ {ε}_{t r}} {R}_{e} ( φ ) + {λρ}_{e}^{IRMv 1} ( φ , 1. ) \qquad ( IRMv1 )$$

Note that although EQ. (7) holds only for squared loss, Arjovsky (2019) put forward that for all differentiable loss functions (w^{T}Φ)^{T}∇_{w}R(w^{T}Φ)=0 if and only if w is optimal for all environments, where matrix Φ parameterizes the data representation. Accordingly, Arjovsky (2019) justifies the choice of ∥∇_{w|w=1.0}Rₑ(w^{T}φ)∥² as an invariance penalty for other loss functions (e.g., cross-entropy loss). However, more recently, a counterexample in which a non-invariant data representation was found for which the penalty ∥∇_{w|w=1.0}Rₑ(w^{T}φ)∥² with logistic loss is arbitrarily small (see Rosenfeld (2021)).

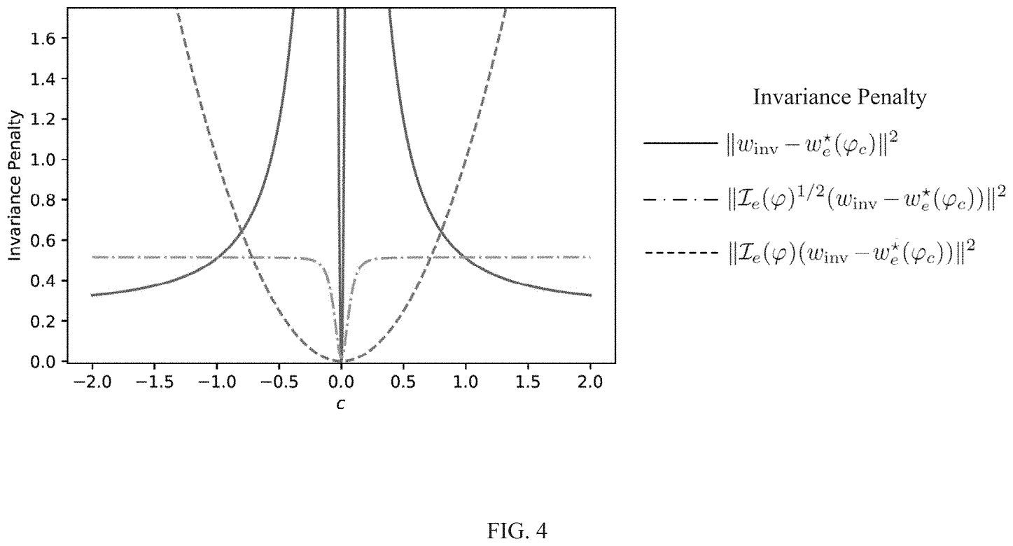

Note that the assumption of invertibility of [symbol] ₑ(φ) was used in the derivation of the invariance penalty ρₑ^{IRMAv1}(φ, w) for squared loss. The role of the eigenstructure of [symbol] ₑ(φ) in relation to invariance penalization is described below in connection with FIG. 4, in particular with respect to existing counterexamples for the two penalties described above.

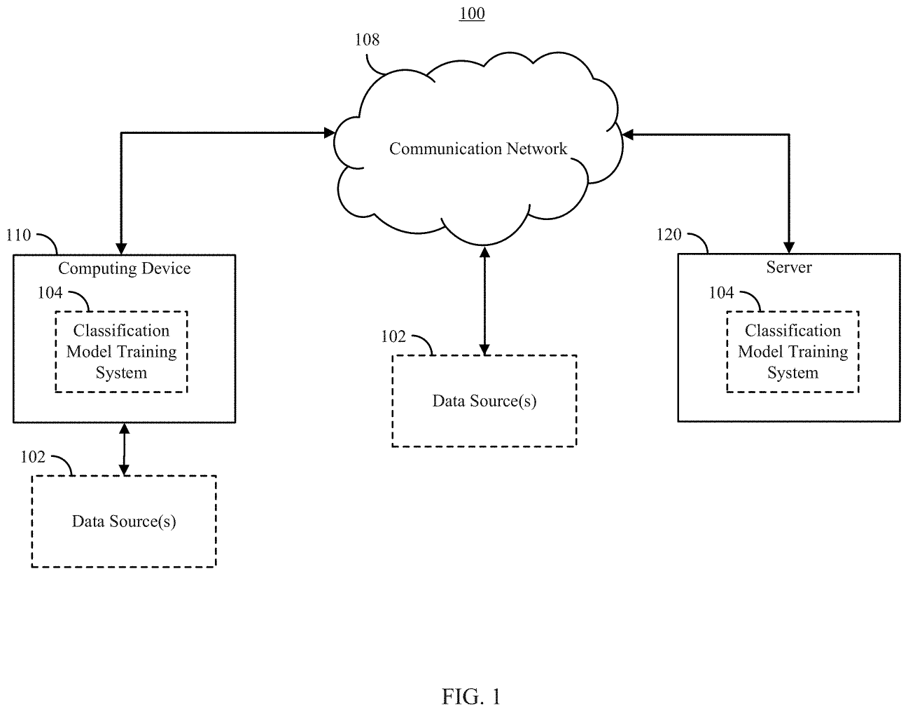

FIG. 1 shows an example 100 of a system for training a model for improved out of distribution performance in accordance with some embodiments of the disclosed subject matter. As shown in FIG. 1, a computing device 110 can receive data from data source 102 or multiple data sources 102. For example, computing device 110 can receive data (e.g., labeled data) that can be used to train a model (e.g., a classification model), and/or data (e.g., unlabeled data) to be provided as input to a trained model (e.g., to classify the input data). In some embodiments, data source 102 can provide any suitable type of data, such as physiological data, image data (e.g., medical image data, conventional digital image data), text data, etc. Data source 102 can provide any data that can be used to train a machine learning model. For example, techniques described in connection with IRMv1 of Arjovsky (2019) have been used in connection with classifying text data Adragna et al. “Fairness and robustness in invariant learning: A case study in toxicity classification.” arXiv:2011.06485 (2020).

In some embodiments, computing device 110 can execute at least a portion of a classification model training system 104 to train a classification model (e.g., a regression model, a neural network such as a convolutional neural network, a feedforward neural network, a recurrent neural network, a kernel regression model, etc.) using data generated in the context of different environments using techniques described herein. In some embodiments, mechanisms described herein can be used in connection with unsupervised learning techniques. For example, techniques described herein can be used in connection with K-means clustering. In such an example, an invariance penalty can be defined based on the differences of the means of clusters across different environments.

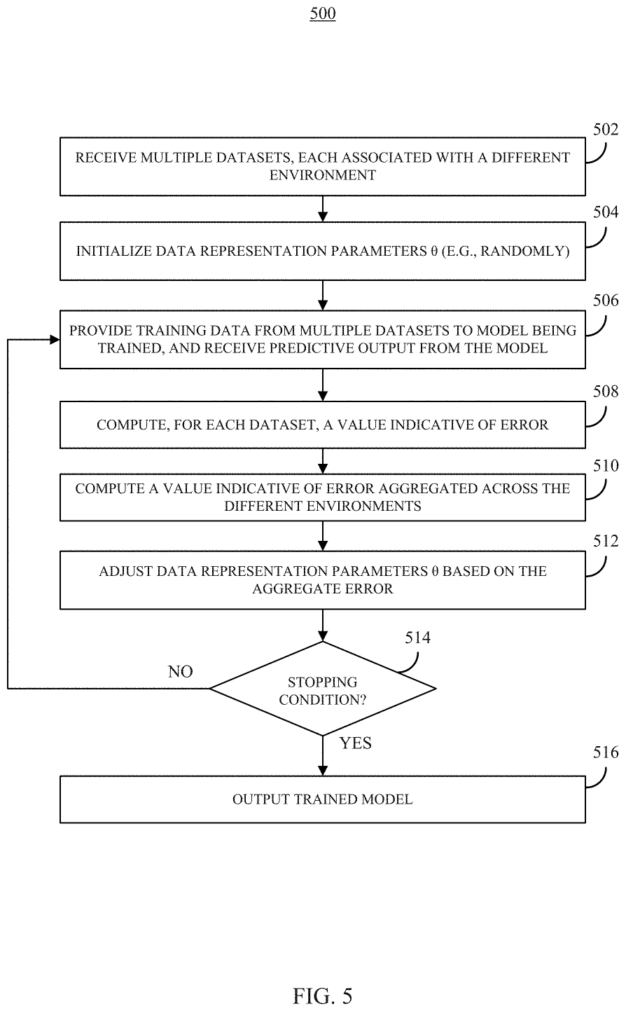

Additionally or alternatively, in some embodiments, computing device 110 can communicate information about data received from data source 102 to a server 120 over a communication network 108, which can execute at least a portion of classification model training system 104. In such embodiments, server 120 can return information to computing device 110 (and/or any other suitable computing device), such as a trained model generated using classification model training system 104. In some embodiments, classification model training system 104 can execute one or more portions of process 500 described below in connection with FIG. 5.

In some embodiments, computing device 110 and/or server 120 can be any suitable computing device or combination of devices, such as a desktop computer, a laptop computer, a smartphone, a tablet computer, a wearable computer, a server computer, a virtual machine being executed by a physical computing device, etc.

In some embodiments, data source 102 can be any suitable source of data that can be used to train a classification model or other suitable predictive model. For example, data source 102 can be implemented as memory (e.g., in a computing device, as removeable memory, etc.) that can store data. As another example, data source 102 can include one or more of physiological sensor(s), an electronic medical records system(s), a medical imaging device(s), a digital camera, etc.

In some embodiments, data sources 102 can be local to computing device 110. For example, data source 102 can be incorporated with computing device 110 (e.g., computing device 110 can be configured as part of a device for generating, capturing, and/or storing data). As another example, data source 102 can be connected to computing device 110 by a cable, a direct wireless link, etc. Additionally or alternatively, in some embodiments, data source 102 can be located locally and/or remotely from computing device 110, and can communicate data to computing device 110 (and/or server 120) via a communication network (e.g., communication network 108).

In some embodiments, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 108 can be a local area network, a wide area network, a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

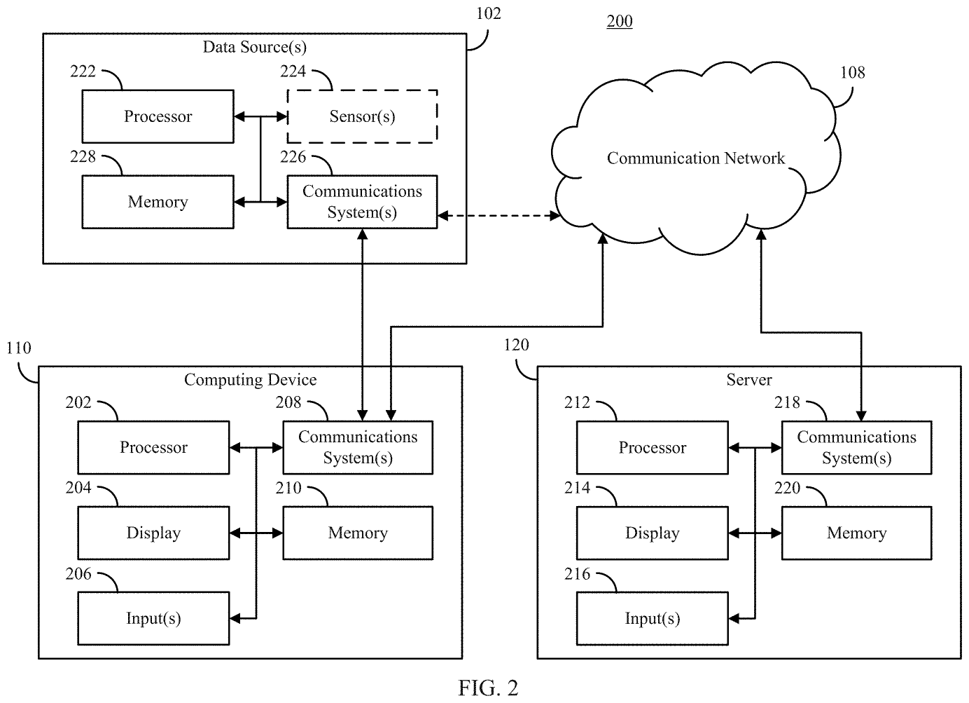

FIG. 2 shows an example 200 of hardware that can be used to implement data source 102, computing device 110, and/or server 120 in accordance with some embodiments of the disclosed subject matter. As shown in FIG. 2, in some embodiments, computing device 110 can include a processor 202, a display 204, one or more inputs 206, one or more communication systems 208, and/or memory 210. In some embodiments, processor 202 can be any suitable hardware processor or combination of processors, such as a central processing unit (CPU), a graphics processing unit (GPU), an application specific integrated circuit (ASIC), a field-programmable gate array (FPGA), etc. In some embodiments, display 204 can include any suitable display devices, such as a computer monitor, a touchscreen, a television, etc. In some embodiments, inputs 206 can include any suitable input devices and/or sensors that can be used to receive user input, such as a keyboard, a mouse, a touchscreen, a microphone, etc.

In some embodiments, communications systems 208 can include any suitable hardware, firmware, and/or software for communicating information over communication network 108 and/or any other suitable communication networks. For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to present content using display 204, to communicate with server 120 via communications system(s) 208, etc. Memory 210 can include any suitable volatile memory, non-volatile memory, storage, or any suitable combination thereof. For example, memory 210 can include RAM, ROM, EEPROM, one or more flash drives, one or more hard disks, one or more solid state drives, one or more optical drives, etc. In some embodiments, memory 210 can have encoded thereon a computer program for controlling operation of computing device 110. In such embodiments, processor 202 can execute at least a portion of the computer program to train a classification model that exhibits improved performance on out of distribution data, present content (e.g., results of a classification, user interfaces, graphics, tables, etc.), receive content from server 120, transmit information to server 120, etc.

In some embodiments, server 120 can include a processor 212, a display 214, one or more inputs 216, one or more communications systems 218, and/or memory 220. In some embodiments, processor 212 can be any suitable hardware processor or combination of processors, such as a CPU, a GPU, an ASIC, an FPGA, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, etc.

In some embodiments, communications systems 218 can include any suitable hardware, firmware, and/or software for communicating information over communication network 108 and/or any other suitable communication networks. For example, communications systems 218 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 110, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a server program for controlling operation of server 120. In such embodiments, processor 212 can execute at least a portion of the server program to transmit information and/or content (e.g., data, a trained classification model, a user interface, etc.) to one or more computing devices 110, receive information and/or content from one or more computing devices 110, receive instructions from one or more devices (e.g., a personal computer, a laptop computer, a tablet computer, a smartphone, etc.), etc.

In some embodiments, data source 102 can include a processor 222, computed tomography (CT) components 224, one or more communications systems 226, and/or memory 228. In some embodiments, processor 222 can be any suitable hardware processor or combination of processors, such as a CPU, a GPU, an ASIC, an FPGA, etc. In some embodiments, sensor(s) 224 can be any suitable components to generate data that can be used to train a classification model and/or be provided as input to a trained classification model.

Note that, although not shown, data source 102 can include any suitable inputs and/or outputs. For example, data source 102 can include input devices and/or sensors that can be used to receive user input, such as a keyboard, a mouse, a touchscreen, a microphone, a trackpad, a trackball, hardware buttons, software buttons, etc. As another example, data source 102 can include any suitable display devices, such as a computer monitor, a touchscreen, a television, etc., one or more speakers, etc.

In some embodiments, communications systems 226 can include any suitable hardware, firmware, and/or software for communicating information to computing device 110 (and, in some embodiments, over communication network 108 and/or any other suitable communication networks). For example, communications systems 226 can include one or more transceivers, one or more communication chips and/or chip sets, etc. In a more particular example, communications systems 226 can include hardware, firmware and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, etc.

In some embodiments, memory 228 can include any suitable storage device or devices that can be used to store instructions, values, data, etc., that can be used, for example, by processor 222 to: control sensor(s) 224, and/or receive data from sensor(s) 224; using a display; communicate with one or more computing devices 110; etc. Memory 228 can include any suitable volatile memory, non-volatile memory, storage, or any suitable combination thereof. For example, memory 228 can include RAM, ROM, EEPROM, one or more flash drives, one or more hard disks, one or more solid state drives, one or more optical drives, etc. In some embodiments, memory 228 can have encoded thereon a program for controlling operation of data source 102. In such embodiments, processor 222 can execute at least a portion of the program to generate data, transmit information and/or content (e.g., data) to one or more computing devices 110, receive information and/or content from one or more computing devices 110, transmit information and/or content (e.g., data) to one or more servers 120, receive information and/or content from one or more servers 120, receive instructions from one or more devices (e.g., a personal computer, a laptop computer, a tablet computer, a smartphone, etc.), etc.

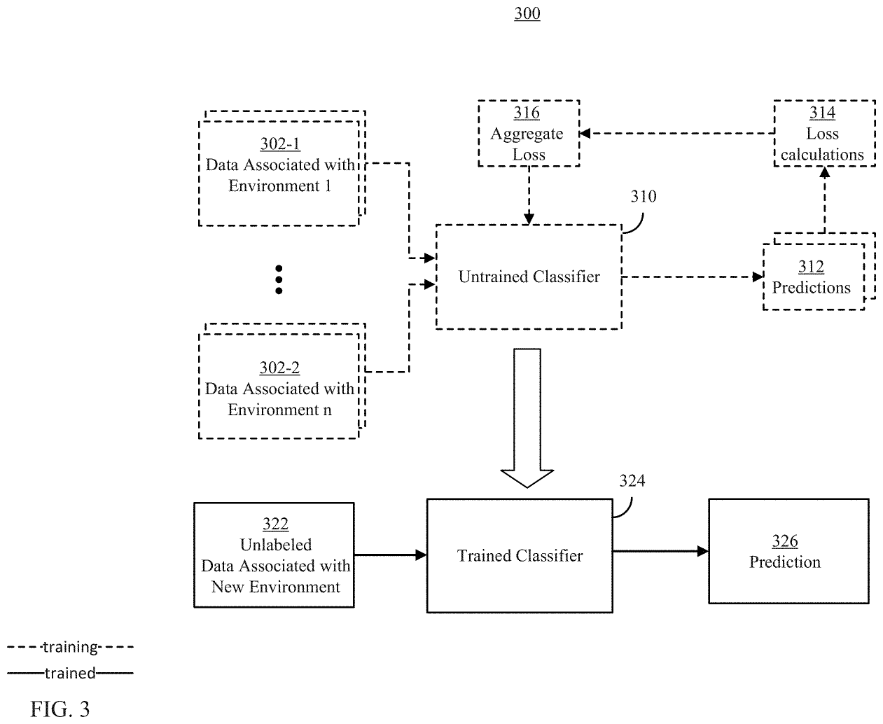

FIG. 3 shows an example 300 of a flow for training a classification model using mechanisms for training a model for improved out of distribution performance in accordance with some embodiments of the disclosed subject matter. As described below in connection with FIG. 4, both ∥w−wₑ*(φ_{c})∥² and ∥ [symbol] ₑ(φ)(w−wₑ*(φ_{c}))∥² may be inappropriate choices for invariance penalty due to their instability in terms of the eigenstructure of [symbol] ₑ (φ). Below, the structure of the risk is described in order to propose another invariance penalty. In particular, in Lemma 1, the sub-optimality gap of risk under an arbitrary classifier is described in comparison to an optimal classifier.

Lemma 1: Considering squared loss function and letting w ∈ [symbol] ^{d}^{_{φ}} and wₑ*(φ) be defined as in EQ. (6). Then,

Rₑ(w^{T}φ)=Rₑ(wₑ*(φ)^{T}φ)+∥ [symbol] ₑ(φ)^{1/2}(w−wₑ*(φ))∥². (10)

In some embodiments, mechanisms described herein can utilize an invariance penalty that is directly comparable to risk, which can be expressed as

$${ρ}_{e}^{I R M v 2} ( φ , w ) := {‖ {{𝒥}_{e} ( {φ}_{c} )}^{\frac{1}{2}} ( w - {w}_{e}^{★} ( φ ) ) ‖}^{2} . \qquad ( 11 )$$

In some embodiments, a relaxation of IRM using the penalty expressed in EQ. (11) can be represented as

$${min}_{φ , w} {\sum }_{e ∈ {ε}_{t r}} {R}_{e} ( {w}^{T} φ ) + {λρ}_{e}^{I R M v 2} ( φ , w ) . \qquad ( 12 )$$

In some embodiments, the relaxation represented in EQ. (12) can be simplified by finding its optimal classifier for a fixed data representation, which can be represented as

$${w}^{⋆} ( φ ) := {arg min}_{w} {\sum }_{e ∈ {ε}_{t r}} {R}_{e} ( {w}^{T} φ ) + {λρ}_{e}^{I R M v 2} ( φ , w ) . \qquad ( 13 )$$

In Lemma 2, the structure of the squared loss is considered and used to find w\hat{ }*(φ).

Lemma 2: Considering the squared loss function and fixed φ, let w*(φ) and w*(φ) as defined by EQS. (6) and (13), respectively, then,

$${w}^{★} ( φ ) = {( {\sum }_{e ∈ {ε}_{t r}} {𝒥}_{e} ( φ ) )}^{- 1} ( {\sum }_{e ∈ {ε}_{t r}} {𝒥}_{e} ( φ ) {w}^{★} ( φ ) ) . \qquad ( 14 )$$

### Moreover,

$${arg min}_{w} {\sum }_{e ∈ {ε}_{t r}} {R}_{e} ( {w}^{T} φ ) = {w}^{★} ( φ ) . \qquad ( 15 )$$

In some embodiments, based on Lemmas 1 and 2, the following relaxation of IRM, which can be referred to as IRMv2, can be used

$${min}_{φ} {\sum }_{e ∈ {ε}_{tr}} {R}_{e} ( {w}^{T} φ ) + {λρ}_{e}^{IRM ν 2} ( φ , {w}^{★} ( φ ) ) . \qquad ( IRMv2 )$$

Pseudo-code that can be used to implement for IRMv2 is described below as Algorithm 1.

Algorithm 1 IRMv2

| | |
|---|---|
| 1: | Input: Data set: Dₑ for e ∈ [symbol] . Loss function: Squared loss, |
| | Parameters: penalty coefficient λ ≥ 0, data representation parameters |
| | θ ∈ [symbol] , learning rate ηₜ, training horizon T. |
| 2: | Initialize θ₁ randomly |
| 3: | for t = 1, 2, . . . , T do |
| 4: | for e ∈ [symbol] do |
| 5: | compute the LSE [symbol] (φ_{θ}_{ₜ}) according to Eq. (6) |
| 6: | compute the optimal classifier [symbol] (φ_{θ}_{ₜ}) according to Eq. (13) |
| 7: | [symbol] (φ_{θ}_{ₜ}) ← [symbol] [symbol] ( [symbol] (φ_{θ}_{ₜ})^{T}φ_{θ}_{ₜ}) + λρₑ^{IRMv2}(φ_{θ}_{ₜ}, [symbol] (φ_{θ}_{ₜ})) |
| 8: | θₜ₊₁ ← θₜ − ηₜ∇θₜ [symbol] (φ_{θ}_{ₜ}) |
| 9: | Output prediction [symbol] (φ_{θ}_{_{T}})^{T}φ_{θ}_{_{T}}. |

Note that there are multiple distinguishing characteristics between IRMv2 and IRMv1. For example, IRMv2 utilizes optimal classifier w*(φ), and IRMv1 sets w=1.0. As another example, the loss function in IRMv2 is squared loss, while IRMv1 allows for utilization of other loss functions. Although this additional flexibility of IRMv1 may appear appealing, as described above, the penalty of IRMv1 can fail to fully capture invariance for at least logistic loss. As yet another example, [symbol] ₑ(φ) is incorporated differently in the invariance penalty term of IRMv1 and IRMv2.

In some embodiments, mechanisms described herein can utilize an adaptive version to choose an invariance penalty similar to the penalty described above in connection with IRMv1, which can be referred to as IRMv1-Adaptive (IRMv1A).

Lemma 3: Let ρₑ^{IRMv1}(φ, w) and ρₑ^{IRMv2}(φ, w) be the invariance penalties of the IRMv1 and IRMv2 defined by EQS. (8) and (11), respectively. Then, λₘᵢₙ( [symbol] ₑ(φ))ρₑ^{IRMv2}(φ, w)≤ρₑ^{IRMv1}(φ, w)≤λₘₐₓ( [symbol] ₑ (φ))ρₑ^{IRMv2 6})

The proof of Lemma 3 directly follows from the definition of the invariance penalties ρₑ^{IRMv1}(φ, w) and ρₑ^{IRMv2}(φ, w), and the fact that for a symmetric matrix A ∈ [symbol] ^{d×d} and a vector u ∈ [symbol] ^{d}, it holds that λₘᵢₙ (A)∥U∥²≤u^{T}Au≤λₘₐₓ(A)∥u∥².

In some embodiments, based on Lemma 3, the penalty coefficient of IRMv1 can be adaptively determined based on the following expression

$${λ}_{e} := \frac{1}{{λ}_{0} + {λ}_{min} ( {𝒥}_{e} ( φ ) )} \qquad ( 17 )$$

where λ₀≥can be a user-specified parameter. Note that this using EQ. (17), λₑ can be adaptively determined, as φ can change throughout a training phase.

As shown in FIG. 3, data 302 associated with various different environments can be used to train an untrained classifier 310 using any suitable techniques or combination of techniques. In some embodiments, untrained classifier 310 can be any suitable type of classification model, which can be trained using any suitable technique or combination of techniques.

In some embodiments, untrained classifier 310 can be initialized using any suitable values (e.g., random values, median values, etc.). For example, parameters associated with untrained classifier 310 can be initialized, such that when data (e.g., data 302-1 associated with environment 1) is provided as input, untrained classifier generates an output 312, which can be associated with a predicted classification. As a more particular example, a set of data representation parameters θ can be initialized.

In some embodiments, untrained classifier 310 can be provided with data 302 associated with each environment, and can generate associated predictions 312. At 314, a computing device (e.g., computing device 110, server 120, etc.) can calculate (e.g., using classification model training system 104) a value(s) indicative of performance of the classifier (e.g., a loss value(s), such as an invariance penalized loss value(s)) associated with each environment. For example, the computing device can use EQ. (6) to calculate a value indicative of performance of untrained classifier 310 on data associated with a particular environment.

In some embodiments, at 316, a computing device (e.g., computing device 110, server 120, etc.) can calculate (e.g., using classification model training system 104) an aggregated value (e.g., an aggregate loss value(s)) indicative of performance of untrained classifier 316 across a set of environments. For example, the computing device can use EQ. (13) to calculate a value indicative of performance of untrained classifier 310 on data across all environments associated with data 302. In some embodiments, the computing device can estimate the aggregate loss at 316 using the invariance penalty described above in connection with EQ. (11).

In some embodiments, a computing device (e.g., computing device 110, server 120, etc.) can update the untrained classifier 310 based on the aggregated loss calculated at 316. For example, the computing device (e.g., via classification model training system 104) can adjust values of data representation parameters θ.

In some embodiments, untrained classifier 310 can be trained until training has converged and/or some other stopping condition has been reached. Untrained classifier 310 with final data representation parameters can be used to implement a trained classifier 324.

As shown in FIG. 3, unlabeled data 322 associated with a particular environment, which may be an environment associated with a set of training data 302, or a new environment, can be provided as input to trained classifier 324, which can output a predicted classification 326.

As described above, training trained classifier 324 using mechanisms described herein can improve performance of trained classifier when provided with data from new and/or diverse environments (e.g., which were not represented, or were underrepresented, in the training data).

For example, considering the setting introduced in Rosenfeld (2021), mechanisms described herein can be evaluated, and theoretical performance of IRM with linear classifier and squared loss, and subsequently IRMv2 can be evaluated. As described below, it can be shown that mechanisms described herein can recover an invariant predictor.

Data used to evaluate whether a predictor exhibits invariance can be generated according to a Structural Equation Model. For example, for each environment e, (X^{e}, Y^{e}) can be generated as

$${X}^{e} = S [ \begin{matrix}{Z}_{c} \\ {Z}_{e}\end{matrix} ] , {Y}^{{e}_{=}} \{ \begin{matrix}1 , & with prob . η \\ - 1 , & with prob . 1 - η\end{matrix} , \qquad ( 18 )$$

where η∈[0,1], and S ∈ [symbol] ^{d×(d}^{ₑ}^{+d}^{_{c}}⁾ is a left invertible matrix, such that there exists S℄ such that S^{†}S=I. In this model, Z_{c} can capture causal variables that are invariant across environments, and Zₑ can capture spurious environment dependent variables.

The variables Z_{c} and Zₑ can be generated as follows

Z_{c}=μ_{c}Y+W_{c} where W_{c}˜ [symbol] (0,σ_{c}²I) (19)

Zₑ=μₑY+Wₑ where Wₑ˜ [symbol] (0,σₑ²I) (20)

where, μ_{c} ∈ [symbol] ^{d}^{_{c}}, μₑ∈ [symbol] ^{d}^{ₑ}, and [symbol] (μ, Σ) denotes multi-variate Gaussian distribution with mean equal to μ and covariance matrix equal to Σ. Additionally, it can be assumed that W_{c}, Wₑ, and Y^{e} are independent for all environments.

For the setting described above in connection with EQS. (18) to (20), the invariant data representation is linear. In particular, for any d≥d_{c}, φ(X^{e})=Φ_{d}X^{e}=Z_{c} is an invariant data representation, where

$${Φ}_{d} := [ \begin{matrix}{I}_{{d}_{c} \times {d}_{c}} & {0}_{{d}_{e} \times {d}_{c}} \\ {0}_{{d}_{c} \times ( d - {d}_{c )}} & {0}_{{d}_{e} \times ( d - {d}_{c )}}\end{matrix} ] \qquad ( 21 )$$

Note that the possibility of finding an invariant predictor depends on the number and the diversity of training environments. For example, non-degeneracy conditions on the training environment under which IRM is guaranteed to find an invariant predictor are described below, provided sufficient number of training environments.

Let |εₜᵣ|>dₑ. As span ({μₑ}_{e∈ε}_{ₜᵣ}), for each e ∈ εₜᵣ there exists a set of coefficients αᵢ^{e} for i ∈ εₜᵣ\e, such that

$${μ}_{e} = {\sum }_{i ∈ {ε}_{t r} ∖ e} {α}_{i}^{e} {μ}_{i} \qquad ( 22 )$$

The set of training environments εₜᵣ can be characterized as a non-degenerate set of environments, if for all e ∈ εₜᵣ it holds that

$${\sum }_{i ∈ {ε}_{t r} ∖ e} {α}_{i}^{e} \neq 1 \qquad ( 23 )$$

$$rank ( {Γ}_{e} ) = {d}_{e} , \qquad ( 24 )$$

where Γₑ can be defined as

$${Γ}_{e} := \frac{1}{1 - {Σ}_{i ∈ {ε}_{t r} ∖ e} {α}_{i}^{e}} ( {σ}_{e}^{2} I + {μ}_{e} {μ}_{e}^{T} - {\sum }_{i ∈ {ε}_{t r} ∖ e} ( {σ}_{i}^{2} I + {μ}_{i} {μ}_{i}^{T} ) {α}_{i}^{e} )$$

The conditions in EQS. (23) and (24) specify that the span of covariance matrices of Zₑ is [symbol] ₑ^{d} R^{d}ₑ. This can eliminate the degrees of freedom on the dependency of the data [symbol] representation on the environment dependent features. Note that the non-degeneracy conditions considered in Rosenfeld (2021) are somewhat similar to EQS. (23) and (24) with a difference in that instead of depending on covariance matrices of Zₑ as in EQ. (24), in Rosenfeld an assumption relies on the variances σₑ². This difference in the non-degeneracy conditions is due to the Rosenfeld considering logistic loss (e.g., rather than squared loss).

Theorem 1: Assume that |εₜᵣ|>dₑ where (X^{e}, Y^{e}) can be generated according to EQ. 18, described above. Consider a linear data representation ΦX=AZ_{c}+BZₑ, and a classifier w(Φ) on top of Φ that is invariant (e.g., w(Φ)=w*(Φ) for all e ∈ εₜᵣ). If non-degeneracy conditions described above in connection with EQS. (22) to (24) hold, then either w(Φ)=0 or B=0.

Comparing the penalties of IRMv1 and IRMv2 for the counterexample in Rosenfeld (2021), Rosenfeld (2021) considers a data representation φ_{∈} where ∈>1 determines the extent to which φ_{∈}(X^{e}) depends on Zₑ. More particularly, φ_{∈} can be represented as

$${φ}_{ϵ} ( {X}^{e} ) := [ \begin{matrix}{Z}_{c} \\ 0\end{matrix} ] + [ \begin{matrix}0 \\ {Z}_{e}\end{matrix} ] {1}_{\{ {Z}_{e} ∉ {Z}_{ϵ} \}} \qquad ( 25 )$$

where {Zₑ∉ [symbol] _{∈}} is an event with P (Zₑ ∈ [symbol] _{∈})≤P_{e,∈} where

$${p}_{e , ε} := exp ( - {d}_{e} min \{ ϵ - 1 , \frac{{( ϵ - 1 )}^{2}}{8} \} ,$$

Z_{c} and Zₑ denote random variables, and [symbol] _{∈} can be expressed as [symbol] _{∈}=∪_{e∈∈}( [symbol] ᵣ(μₑ)∪ [symbol] ᵣ(−μₑ) where r:=\sqrt{∈σₑ²dₑ} and [symbol] ᵣ(μ) denotes the [symbol] −2 ball of radius r entered at μ. Rosenfeld (2021) put forward that the invariance penalty of IRMv1 decays at a rate faster than P_{e,∈}² as ∈ grows. Accordingly, the penalty may be arbitrarily small for a large enough ∈.

In some embodiments, an invariant data representation for this setting can be φ_{∈}(X^{e}) with ∈=1. Additionally, Appendix B, section B.2 includes a description indicating that [symbol] ( [symbol] ₑ(φ))≥c/P_{e,∈} for some constant c that is independent of ∈. Accordingly, [symbol] ₑ(φ) is ill-conditioned when the penalty of IRMv1 is small. Appendix A includes details related to EQS. (1) and (13). Appendix A is hereby incorporated by reference herein in its entirety.

FIG. 4 shows an example of various invariance penalties that can be used with invariance risk minimization techniques. The invariance penalty described in Arjovsky (2019) considered an example in which φ_{c}(x) is parameterized by a variable c ∈ R, where c=0 for the invariant data representation (see, e.g., Appendix B, section B.1 for additional details; Appendix B is hereby incorporated by reference herein in its entirety). FIG. 4 shows various candidate invariance penalties at the invariant classifier w=wᵢₙᵥ. As shown in FIG. 4, ∥wᵢₙᵥ−wₑ*(φ_{c})∥² is a poor choice for use as an invariance penalty as it is discontinuous at the invariant representation with c=0, and vanishes as c→∞. Note that [symbol] ₑ(φ_{c}) is ill-conditioned for both small and large values of c. More precisely, it holds that

$${lim}_{c \to 0} κ ( {𝒥}_{e} ( {φ}_{c} ) ) = {lim}_{c \to + ∞} κ ( {𝒥}_{e} ( {φ}_{c} ) ) = + ∞ ,$$

where k(·) denotes the condition number. That is, for a normal matrix A, the condition number of matrix A is k(A):=|λₘₐₓ(A)|/|λₘᵢₙ(A)|, where λₘₐₓ and λₘᵢₙ denote maximum and minimum eigenvalues associated with matrix A, respectively. Although multiplying (wᵢₙᵥ−Wₑ*(φ_{c})) by [symbol] ₑ(φ_{c}) can mitigate poor behavior of the invariance penalty for this example, it may not appropriately capture invariance in general (e.g., as argued Rosenfeld (2021)).

In the counterexample described in Rosenfeld (2021), a setting in which the data is generated according to a structural equation model (SEM) was considered. For this setting, there exists a non-invariant data representation under which ∥∇_{w}Rₑ(w^{T}φ)∥² with logistic loss is arbitrarily small and accordingly is likely to perform poorly as an invariance penalty. For the described counterexample, the matrix [symbol] ₑ(φ_{c}) is also ill-conditioned. Additional details related to a derivation of the condition number of [symbol] ₑ(φ_{c}) is described for Arjovsky (2019) and Rosenfeld (2021) in Appendix B, sections B.1 and B.2, respectively.

FIG. 5 shows an example of a process for training a model for improved out of distribution performance in accordance with some embodiments of the disclosed subject matter. At 502, process 500 can receive multiple dataset, each dataset associated with a different environment. In some embodiments, the datasets can be known to be associated with different environments (e.g., collected at different hospitals, collected at different locations, etc.). Additionally or alternatively, in some embodiments, a dataset can be divided into environments based on a variable associated with the data. The variable used to subdivide the dataset can be a variable that is unlikely to be causal in connection with the target variable. For example, a dataset can be subdivided based on zip code associated with the data where geographic location is unlikely to be a causal variable. For example, different datasets can be generated using different equipment. As another example, different datasets can be generated with different background conditions. In a more particular example, in images, a subject of an image can be within different types of backgrounds (e.g., backgrounds with different characteristics, such as color, pattern, etc.). As yet another example, different datasets can be generated and/or recorded at different times and/or locations. As a more particular example, in medical data sets, the zip code or State that a patient resides in can be a reasonable factor to divide data sets into various environments. As still another example, different datasets can be generated by different entities. As a more particular example, the MNIST data set is a collection of digits written by different people. In such an example, data collected from each person can be considered an environment.

At 504, process 500 can initialize data representation parameters θ using any suitable technique or combination of techniques. For example, process 500 can initialize data representation parameters θ randomly. As another example, process 500 can initialize data representation parameters θ to a median value (e.g., in a middle of a range of possible values).

At 506, process 500 can provide data from the different datasets as training data to a model being trained, and can receive predictive outputs from the model corresponding to each input.

At 508, process 500 can compute, for each of the multiple datasets, a value indicative of error based on a label associated with the input and the predictive output using any suitable technique or combination of techniques. In some embodiments, process 500 can compute the value indicative of error based on EQ. (6).

At 510, process 500 can compute a value indicative of error aggregated across the different environments using any suitable technique or combination of techniques. In some embodiments, process 500 can compute the value indicative of error across environments based on EQ. (13).

At 512, process 500 can adjust parameters θ based on the aggregate error using any suitable technique or combination of techniques. For example, process 500 can modify parameters θ using the learning rate, and the aggregated loss, as described above in connection with Algorithm 1.

At 514, process 500 can determine whether a stopping condition has been satisfied. In some embodiments, process 500 can identify whether any suitable stopping condition has been satisfied. For example, process 500 can determine whether a predetermined number of training iterations and/or epochs have been carried out. As another example, process 500 can determine whether a change in accuracy has improved by less than a threshold amount for at least a predetermined number of iterations and/or epochs. As yet another example, process 500 can determine whether the invariance penalty has fallen below a predetermined threshold.

If process 500 determines that a stopping condition has not been satisfied (“NO” at 514), process 500 can return to 506, and continue to train the model. Otherwise, if process 500 determines that a stopping condition has been satisfied (“YES” at 514), process 500 can move to 516.

At 516, process 500 can output a trained model. For example, process 500 can record parameters associated with the model to memory. As another example, process 500 can transmit parameters associated with the model to another device (e.g., a device that did not execute process 500).

FIG. 6 shows an example of test errors observed for various classification models, including classification models trained in accordance with some embodiments of the disclosed subject matter. FIG. 6 shows test errors for various different models and examples with (dᵢₙᵥ, dₛₚᵤ, dₑₙᵥ)=(5, 5, 3). The errors for Examples 1.E0 through 1s.E2 are in mean square error (MSE) and all others are classification error. The empirical mean and the standard deviation are computed using 10 independent experiments. An ‘s’ indicates a scrambled variation of its corresponding problem setting. For example, Example 1s is a scrambled variation of the Example 1 regression setting.

The efficacy of various implementations of IRM were evaluated, including IRMv2, IRMv1A, and IRMv1, using InvarianceUnitTests (e.g., as described in Aubin et al., “Linear unit tests for invariance discovery,” in Causal Discovery and Causality-Inspired Machine Learning Workshop at NeurIPS (2020)) and DomainBed (e.g., as described in Gulrajani et al., “In search of lost domain generalization,” arXiv:2006.07461 (2020)), two test beds for evaluation of domain generalization techniques. In particular, results in FIG. 6 show that techniques described herein generalizes in one of the InvarianceUnitTests where all other techniques failed (i.e., exhibited tests accuracies that are comparable to random guessing).

FIG. 6 shows results generated based on an evaluation of the efficacy of mechanisms described herein for invariance discovery on the InvarianceUnitTests. These unit-tests entail three classes of low-dimensional linear problems, each capturing a different structure for inducing spurious correlations. FIG. 6 shows a performance comparison on the InvarianceUnitTests among IRMv2, IRMv1A, IRMv1, ERM, Inter-environmental Gradient Alignment (IGA) (e.g., as described in Koyama et al., “Out-of-distribution generalization with maximal invariant predictor,” arXiv:2008.01883 (2020)), and AND-Mask (e.g., as described in Parascandolo et al., “Learning explanations that are hard to vary,” arXiv:2009.00329 (2020)). The IGA technique seeks to elicit invariant predictors by an invariance penalty in terms of the variance of the risk under different environments. The AND-Mask method, at each step of the training process, updates the model using the direction where gradient (of the loss) signs agree across environments.

The data set for each problem falls within a multi-environment setting described above in connection with EQ. (1), with the number of environments nₑ=10⁴. For all problems, the input x^{e} ∈ [symbol] ^{d} was constructed as xₑ ∈ (xᵢₙᵥ^{e}, xₛₚᵤ^{e}) where xᵢₙᵥ^{e} ∈ [symbol] ^{d}^{ᵢₙᵥ} and xₛₚᵤ^{e} ∈ [symbol] ^{d}^{ₛₚᵤ} denote the invariant and the spurious features, respectively. To make the problems more realistic, each experiment was repeated with scrambled inputs by multiplying x^{e} by a rotation matrix. In each problem, the spurious correlations that exist in the training environments are discarded in the test environment by random shuffling. As a basis for comparison, an Oracle ERM was implemented (labeled “Oracle” in FIG. 6) where the spurious correlations are shuffled in the training data sets as well, such that ERM can readily identify them.

Example 1 considers a regression problem based on Structural Equation Models (SEMs) where the target variable is a linear function of the invariant variables and the spurious variables are linear functions of the target variable. Example 2 considers a classification problem (inspired by the infamous cow vs. camel example described in Beery et al., “Recognition in terra incognita,” in Proceedings of the European Conference on Computer Vision (2018)) where spurious correlations are interpreted as background color. Example 3 is based on a classification experiment described in Parascandolo (2020) where the spurious correlations provide a shortcut in minimizing the training error while the invariant classifier takes a more complex form.

The test errors of all techniques on the three examples and their scrambled variations are summarized in FIG. 6. Note that on these structured unit-tests, most non-ERM techniques are only successful in eliciting an invariant predictor in the linear regression case (Example 1). In particular, other than IRMv2 on Example 2 and IRMv1 on Example 3, all techniques fail on these cases (i.e., exhibit test errors comparable to random guessing). As the structure of the spurious correlation is different in each of these examples, these mixed results highlight the challenge of constructing methods that generalize well with minimal reliance on the underlying causal structure.

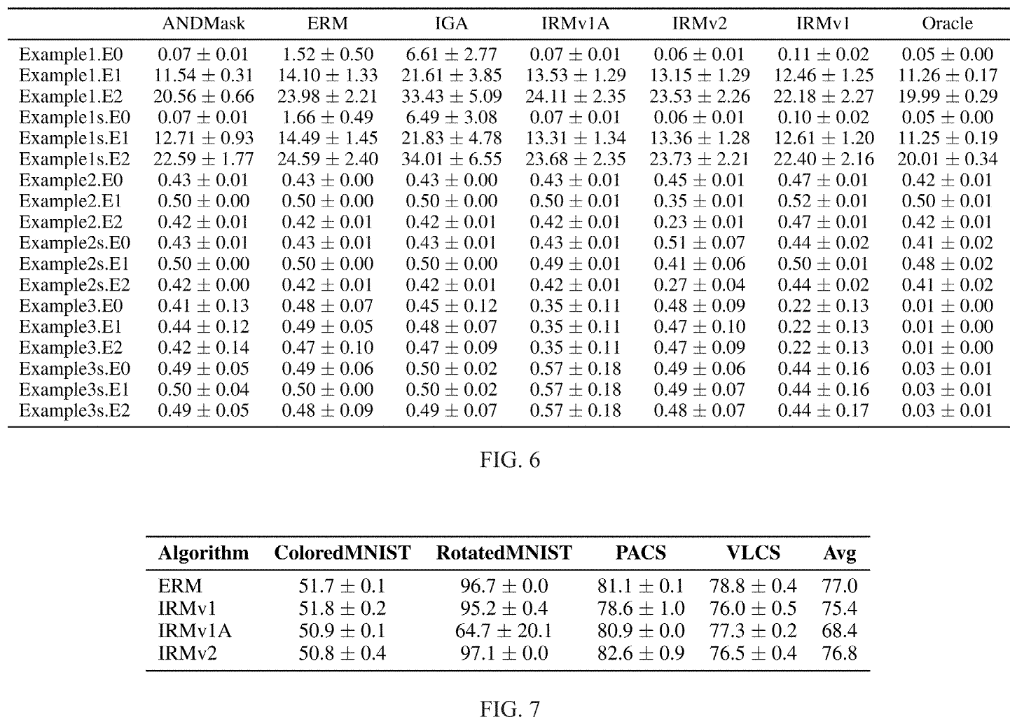

FIG. 7 shows an example of test accuracy observed for various classification models, including classification models trained in accordance with some embodiments of the disclosed subject matter. DomainBed is an extensive framework to test domain generalization algorithms for image classification tasks on various benchmark data sets. In a series of experiments, Gulrajani (2020) describes experiments showing that enabled by data augmentation various state-of-the-art generalization techniques perform similar to each other and ERM on several benchmark data sets.

Although the integration of additional data sets and algorithms to DomainBed is straightforward, performing an extensive set of experiments requires significant computational resources. For this reason, the scope of experiments on DomainBed was limited to the comparison of ERM, IRMy1, IRMv1A, and IRMv2. FIG. 7 shows the test accuracy of ERM and different implementations of IRM on the benchmark datasets. Model selection of the DomainBed is chosen as training-domain validation set.

Similar to we observe that no method significantly outperforms others on any of the benchmark data sets. A more complete set of results on DomainBed with various model selection methods are described in Appendix C, which is hereby incorporated herein by reference in its entirety. As these data sets are image based and equipped with data augmentation, they may not provide comprehensive insight on the strengths and weaknesses of domain generalization techniques on other modes of data (e.g., gathered in real-world applications).

### Further Examples Having a Variety of Features

Implementation examples are described in the following numbered clauses:

1. A method for training a model for improved out of distribution performance, the method comprising: receiving a plurality of datasets, each dataset associated with a different environment e; initializing data representation parameters associated with a model; providing the plurality of datasets as input to the model; receiving, from the model, an output associated with each input; determining an optimal classifier for the data representation parameters using an invariance penalty based on a square root of matrix [symbol] ₑ(φ):=E_{X}_{^{e}}[(φ(X^{e})φ(X^{e})^{T}] for each environment e, where φ represents the data representation parameters, and φ(X^{e}) is the dataset associated with environment e modified based on the data representation parameters; calculating a loss value for the optimal classifier across the plurality of datasets; and modifying the data representation parameters based on the loss value.

2. The method of clause 1, wherein the model comprises a convolutional neural network.

3. The method of clause 1, wherein the model comprises a regression model.

4. The method of any one of clauses 1 to 3, wherein determining the optimal classifier comprises determining w*(φ) using

$${w}^{★} ( φ ) := {arg min}_{w} {\sum }_{e ∈ {ε}_{t r}} {ℛ}_{e} ( {w}^{T} φ ) + {λρ}_{e}^{I R M v 2} ( φ , w ) , \\ where {ρ}_{e}^{I R M v 2} ( φ , w ) := {‖ {{𝒥}_{e} ( {φ}_{c} )}^{\frac{1}{2}} ( w - {w}_{e}^{★} ( φ ) ) ‖}^{2}$$

is an invariance penalty, where wₑ*(φ)= [symbol] ₑ(φ)⁻¹E_{X}_{^{e}}_{, Y}_{^{e}}[φ(X^{e}) Y^{e}].

5. The method of any one of clauses 1 to 4, wherein calculating the loss value for the optimal classifier across the plurality of datasets comprises calculating [symbol] ₜ(φ_{θ}_{ₜ})=Σ_{e∈ε}_{ₜᵣ} [symbol] ₑ(w*(φ_{θ}_{ₜ})^{T}φ_{θ}_{ₜ})+λρₑ^{IRM2}(φ_{θ}_{ₜ}, w*(φ_{θ}_{ₜ})), where θₜ comprises the data representation parameters at time t.

6. The method of clause 5, wherein modifying the data representation parameters based on the loss value comprises setting data representation parameters θₜ₊₁←θ^{t}−η∇_{θ} [symbol] ₜ(φ_{θ}_{ₜ}).

7. The method of any one of clauses 1 to 6, wherein a first environment of the plurality of environments corresponds to a first hospital and a second environment of the plurality of environments corresponds to a second hospital.

8. A system for training a model for improved out of distribution performance, the system comprising: at least one processor configured to: perform a method of any of clauses 1 to 7.

9. A non-transitory computer readable medium containing computer executable instructions that, when executed by a processor, cause the processor to perform a method of any of clauses 1 to 7.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above described steps of the processes of FIG. 5 can be executed or performed in any order or sequence not limited to the order and sequence shown and described in the figures. Also, some of the above steps of the processes of FIG. 5 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for training a model for improved out of distribution performance, the method comprising:
receiving a plurality of datasets, each dataset associated with a different environment e;
initializing data representation parameters associated with a model;
providing the plurality of datasets as input to the model;
receiving, from the model, an output associated with each input;
determining an optimal classifier for the data representation parameters using an invariance penalty based on a square root of matrix [symbol] ₑ(φ):=E_{X}_{^{e}}[φ(X^{e})φ(X^{e})^{T}] for each environment e, where φ represents the data representation parameters, and φ(X^{e}) is the dataset associated with environment e modified based on the data representation parameters;
calculating a loss value for the optimal classifier across the plurality of datasets; and
modifying the data representation parameters based on the loss value.

2. The method of claim 1, wherein the model comprises a convolutional neural network.

3. The method of claim 1, wherein the model comprises a regression model.

4. The method of claim 1, wherein determining the optimal classifier comprises determining w*(φ) using
$${w}^{★} ( φ ) := {arg min}_{w} {\sum }_{e ∈ {ε}_{t r}} {ℛ}_{e} ( {w}^{T} φ ) + {λρ}_{e}^{I R M v 2} ( φ , w ) , \\ where {ρ}_{e}^{I R M v 2} ( φ , w ) := {‖ {{𝒥}_{e} ( {φ}_{c} )}^{\frac{1}{2}} ( w - {w}_{e}^{★} ( φ ) ) ‖}^{2}$$
is an invariance penalty, where wₑ*(φ)= [symbol] ₑ(φ)⁻¹E_{X}_{^{e}}_{,Y}_{^{e}}[φ(X^{e})Y^{e}].

5. The method of claim 1, wherein calculating the loss value for the optimal classifier across the plurality of datasets comprises calculating [symbol] ₜ(φ_{θ}_{ₜ})=Σ_{e∈ε}_{ₜᵣ} [symbol] ₑ(w*(φ_{θ}_{ₜ})^{T}φ_{θ}_{ₜ})+λρₑ^{IRMv2}(φ_{θ}_{ₜ},w*(φ_{θ}_{ₜ})), where θₜ comprises the data representation parameters at time t.

6. The method of claim 5, wherein modifying the data representation parameters based on the loss value comprises setting data representation parameters θₜ₊₁←θₜ−η∇_{θ} [symbol] ₜ(φ_{θ}_{ₜ}).

7. The method of claim 1, wherein a first environment of the plurality of environments corresponds to a first hospital and a second environment of the plurality of environments corresponds to a second hospital.

8. A system for training a model for improved out of distribution performance, the system comprising:
at least one processor configured to:
receive a plurality of datasets, each dataset associated with a different environment e;
initialize data representation parameters associated with a model;
provide the plurality of datasets as input to the model;
receive, from the model, an output associated with each input;
determine an optimal classifier for the data representation parameters using an invariance penalty based on a square root of matrix [symbol] ₑ(φ):=E_{X}_{^{e}}[φ(X^{e})φ(X^{e})^{T}] for each environment e, where φ represents the data representation parameters, and φ(X^{e}) is the dataset associated with environment e modified based on the data representation parameters;
calculate a loss value for the optimal classifier across the plurality of datasets; and
modify the data representation parameters based on the loss value.

9. The system of claim 8, wherein the model comprises a convolutional neural network.

10. The system of claim 8, wherein the model comprises a regression model.

11. The system of claim 8, wherein the at least one processor is further configured to:
determine w*(φ) using
$${w}^{★} ( φ ) := {arg min}_{w} {\sum }_{e ∈ {ε}_{t r}} {ℛ}_{e} ( {w}^{T} φ ) + {λρ}_{e}^{I R M v 2} ( φ , w ) ,$$
$$where {ρ}_{e}^{I R M v 2} ( φ , w ) := {‖ {{𝒥}_{e} ( {φ}_{c} )}^{\frac{1}{2}} ( w - {w}_{e}^{★} ( φ ) ) ‖}^{2}$$
is an invariance penalty, where wₑ*(φ)= [symbol] ₑ(φ)⁻¹E_{X}_{^{e}}_{,Y}_{^{e}}[φ(X^{e}) Y^{e}].

12. The system of claim 8, wherein the at least one processor is further configured to: calculate [symbol] ₜ(φ_{θ}_{ₜ})=Σ_{e∈ε}_{ₜᵣ} [symbol] ₑ(w*(φ_{θ}_{ₜ})^{T}φ_{θ}_{ₜ})+λρₑ^{IRMv2}(φ_{θ}_{ₜ}, w*(φ_{θ}_{ₜ})), where θₜ comprises the data representation parameters at time t.

13. The system of claim 12, wherein the at least one processor is further configured to:
sett data representation parameters θₜ₊₁←θₜ−η∇_{θ} [symbol] ₜ(φ_{θ}_{ₜ}).

14. The system of claim 8, wherein a first environment of the plurality of environments corresponds to a first hospital and a second environment of the plurality of environments corresponds to a second hospital.

15. A non-transitory computer readable medium containing computer executable instructions that, when executed by a processor, cause the processor to perform a method for training a model for improved out of distribution performance, the method comprising:
receiving a plurality of datasets, each dataset associated with a different environment e;
initializing data representation parameters associated with a model;
providing the plurality of datasets as input to the model;
receiving, from the model, an output associated with each input;
determining an optimal classifier for the data representation parameters using an invariance penalty based on a square root of matrix [symbol] ₑ(φ) :=E_{X}_{^{e}}[φ(X^{e})φ(X^{e})^{T}] for each environment e, where φ represents the data representation parameters, and φ(X^{e}) is the dataset associated with environment e modified based on the data representation parameters;
calculating a loss value for the optimal classifier across the plurality of datasets; and
modifying the data representation parameters based on the loss value.

16. The non-transitory computer readable medium of claim 15, wherein the model comprises a convolutional neural network.

17. The non-transitory computer readable medium of claim 15, wherein the model comprises a regression model.

18. The non-transitory computer readable medium of claim 15, wherein determining the optimal classifier comprises determining w*(φ) using
$${w}^{★} ( φ ) := {arg min}_{w} {\sum }_{e ∈ {ε}_{t r}} {ℛ}_{e} ( {w}^{T} φ ) + {λρ}_{e}^{I R M v 2} ( φ , w ) ,$$
$$where {ρ}_{e}^{I R M v 2} ( φ , w ) := {‖ {{𝒥}_{e} ( {φ}_{c} )}^{\frac{1}{2}} ( w - {w}_{e}^{★} ( φ ) ) ‖}^{2}$$
is an invariance penalty, where wₑ*(φ)= [symbol] ₑ(φ)⁻¹E_{X}_{^{e}}_{, Y}_{^{e}}[φ(X^{e})Y^{e}].

19. The non-transitory computer readable medium of claim 15, wherein calculating the loss value for the optimal classifier across the plurality of datasets comprises calculating [symbol] ₜ(φ_{θ}_{ₜ})=Σ_{e∈ε}_{ₜᵣ} [symbol] ₑ(w*(φ_{θ}_{ₜ}^{T}φ_{θ}_{ₜ})+λρₑ^{IRMv2}(φ_{θ}_{ₜ},w*(φ_{θ}_{ₜ})), where θₜ comprises the data representation parameters at time t.

20. The non-transitory computer readable medium of claim 19, wherein modifying the data representation parameters based on the loss value comprises setting data representation parameters θₜ₊₁←θₜ−η∇_{θ} [symbol] ₜ(φ_{θ}_{ₜ}).

21. The non-transitory computer readable medium of claim 15, wherein a first environment of the plurality of environments corresponds to a first hospital and a second environment of the plurality of environments corresponds to a second hospital.
